(19) United States
(12) Patent Application Publication
(10) Pub. No.: US 2021/0303496 A1
(43) Pub. Date: Sep. 30, 2021

(54) ACTUATION OF DATA TRANSMISSION LANES BETWEEN STATES

(71) Applicant: Hewlett-Packard Development Company, L.P., Spring, TX (US)

(72) Inventors: Glen Douglas DOWER, Fort Collins, CO (US); Shane Ward, Fort Collins, CO (US)

(21) Appl. No.: 16/482,314

(22) PCT Filed: Dec. 15, 2017
(86) PCT No.: PCT/US17/66804

§ 371 Date: Jul. 31, 2019

(51) Int. Cl. G06F 13/364; G06F 13/40

(52) U.S. Cl. CPC G06F 13/364; G06F 2213/0026; G06F 13/4004; G06F 13/4068

(57) ABSTRACT

A host device may include a port, a pair of data transmission lanes extending from the port, a switch to selectively actuate the pair of data transmission lanes between a data transmitting state and a data receiving state and a host interface controller to control the switch to selectively actuate the pair of data transmission lanes to one of the data transmitting state and the data receiving state based upon at least one data transfer request.

### BACKGROUND

Data transfers involve the transmission of data between different devices. Such data transfers are initiated by data transfer requests. Within each device, the data is transmitted from a port across pairs of data transmission lanes. In full-duplex transfers, some of the pairs of data transmission lanes transmit data to the port while others receive data from the port.

### BRIEF DESCRIPTION OF THE DRAWINGS

FIG. 1 is a diagram schematically illustrating portions of an example host device.

FIG. 2 is a flow diagram of an example method for controlling an input/output system of a host device.

FIG. 3 is a diagram schematically illustrating portions of an example data transfer system.

FIG. 4 is a flow diagram of an example method for controlling an input/output system of a host device.

FIG. 5 is a diagram schematically illustrate portions of an example data transfer system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

In many devices, high-speed input/output (I/O) communications are carried out with fixed transmit (Tx) and fixed receive (Rx) lines, each line comprising a pair of data transmission lanes.

Disclosed are example host devices, methods and computer-readable mediums that enhance available bandwidth by dynamically changing which lines are transmit lines and which lines are receive lines based upon characteristics of at least one data transfer request. In one implementation, the lines are dynamically changed between data transmitting states and data receiving states based upon characteristics of an individual data transfer request, on a request by request basis. In other implementations, the lines are dynamically changed between data transmitting states and data receiving states based on the aggregate, collective, mean, or mode characteristics of a group of data transfer requests.

With such a data transfer request or a group of data transfer requests, dataflow may be unequal or asymmetrical in that a first larger amount of data may be transferred from a first device to a second device while a smaller amount of data is transferred from the second device to the first device pursuant to the data transfer request or group of data transfer requests. A device that is to receive larger amounts of data than it is to transmit pursuant to at least one data transmission request may automatically adjust the states of the data lines of the data receiving device such that a majority of the data lines are in data receiving states. A device that is to transmit larger amounts of data than it is to receive pursuant to the at least one data transmission request may automatically adjust the states of the data lines of the data transmitting device such that a majority of the data lines are in data transmitting states. As a result, the states of the different data transmission lanes are dynamically and automatically adjusted to take into account the characteristics of the particular data transmission transaction, increasing the speed of the transaction without changing clock speed, without changing electrical characteristics of the device, without detrimentally impacting signal integrity and/or without introducing additional routing concerns.

Disclosed herein is an example apparatus in the form of a host device. The host device may include a port, a pair of data transmission lanes extending from the port, a switch to selectively actuate the pair of data transmission lanes between a data transmitting state and a data receiving state and a host interface controller to control the switch to selectively actuate the pair of data transmission lanes to one of the data transmitting state and the data receiving state based upon at least one data transfer request.

Disclosed herein is an example method to enhance bandwidth of an I/O system. The method may include determining an amount of data to be transmitted in accordance with at least one data transfer request and selectively actuating at least one pair of data transmission lanes of a port between the data transmitting state and a data receiving state based upon the determined amount of data.

Disclosed herein is an example non-transitory computer-readable medium that contains instructions to direct a processing unit to enhance bandwidth of an I/O system. The instructions may direct the processing unit to receive at least one data transfer request, wherein the at least one data transfer request is for an amount of data. The instructions may direct the processing unit to compare the amount of data to a predefined threshold. The threshold may be in the form of a numerical threshold or a percentage threshold. Based upon the comparison, the instructions may direct the processing unit to output control signals which actuate at least one pair of data transmission lanes of a port to a selected one of a data transmitting state and a data receiving state based upon the comparison.

In some implementations, multiple pairs of data transmission lanes, multiple lines, may be concurrently switched or actuated at a time to a selected one of the data transmitting state and the data receiving state. In some implementations, the percentage of the total number of data transmission lanes that are actuated or switched to one state or the other may vary based upon the amount of data to be transmitted or received in accordance with at least one data transmission request. In some implementations, the total number of data transmission lines that are in the data transmitting state versus the total number of data transmission lines that are in the data receiving state may be proportional to the amount of data that is being transmitted from the device relative to the amount of data that is being received by the device. For example, a first number of pairs of data transmission lanes may be actuated to a data transmitting state in response to a single data transmission request or a group of data transmission requests requesting a first amount of data to be transmitted. A second greater number of pairs of data transmission lanes may be actuated to a data transmitting state in response to a single data transmission request or a group of data transmission requests requesting a second larger amount of data to be transmitted. A third greater number of pairs of data transmission lanes may be actuated to a data transmitting state in response to a single data transmission request or a group of data transmission requests requesting transmission a third amount of data, larger than the second amount of data, and so on.

By way of another example, a first number of pairs of data transmission lanes may be actuated to a data receiving state in response to a single data transmission request or a group of data transmission requests requesting a first amount of data to be received. A second greater number of pairs of data transmission lanes may be actuated to a data receiving state in response to a single data transmission request or a group of data transmission requests requesting a second larger amount of data to be received. A third greater number of pairs of data transmission lanes may be actuated to a data transmitting state in response to a single data transmission request or a group of data transmission request requesting the receipt of a third amount of data, larger than the second amount of data, and so on.

In one implementation, the evaluation of the single data transmission request or the group of data transmission requests and the determination of how to dynamically adjust a state of the pairs of data transmission lanes between transmitting and receiving states is carried out by a host interface controller of a host device. In one implementation, the host interface controller may control at least one switch that selectively actuates the various pairs of data transmission lanes between data transmitting and data receiving states. In one implementation, the host interface controller of the host device additionally transmits control signals to a peripheral interface controller of the second device causing the data transmission lanes of the peripheral device to be automatically actuated between data transmitting and data receiving states based upon the amount of data being transmitted in accordance with the at least one data transmission request.

In one implementation, the host device may comprise data transmitting hardware and data receiving hardware, wherein at least one switch, under control of the host interface controller, may selectively connect at least one pair of data transmission lanes to the data transmitting hardware to actuate the at least one pair of data transmission lanes to the data transmitting state or to selectively connect at least one pair of data transmission lanes to the data receiving hardware to actuate the at least one pair of data transmission lanes to the data receiving state. In some implementations, the host device may further comprise a data transmitting buffer connected to the data transmitting hardware and a data receiving buffer connected to the data receiving hardware.

In some implementations, the host interface controller automatically outputs control signals to a switch to actuate a pair of data lines to one of a data transmitting state or a data receiving state based upon an amount of data being transmitted and a destination for the data in accordance with at least one data transfer request.

FIG. 1 schematically illustrates portions of an example host device 20. FIG. 1 illustrates portions of an example I/O system of host device 20. Host device 20 enhances the bandwidth of its I/O system by dynamically actuating at least one pair of data transmission lanes of a port between the data transmitting state and a data receiving state based upon characteristics of at least one data transfer request. Host device 20 comprises port 24, data line 26, switch 30 and a host interface controller 44.

Port 24 comprises a connector by which host device 20 may be communicatively connected to another device, such as a peripheral device. Port 24 may comprise various pins or receptacles facilitating the transmission of electrical signals for transmitting and receiving data signals pursuant to data transfer requests. In one implementation, port 24 may comprise a universal serial bus (USB) type port that would follow the USB protocol. In another implementation, port 24 may comprise a Peripheral Component Interconnect Express (PCIe) port which comprises a high-speed serial connection that follows a high-speed serial computer expansion bus standard. In yet other implementations, port 24 may comprise other forms of connections that follow other protocols or standards.

Data line 26 extends from port 24 and communicates electrical signals, representing data, to other components of device 20. Data line 26 comprises a pair 27 of differential data lanes 28A, 28B (collectively referred to as lanes 28). Although FIG. 1 schematically illustrates a single data line 26 comprising a single pair 27 of data lanes 28, it should be appreciated that device 20 comprises multiple data lines 26. At least a portion of the total number of data lines 26 are selectively actuatable by switch 30 between a data transmitting state and a data receiving state. In one implementation, a predetermined portion of the total number of data lines 26 is fixed in either a data transmitting state or a data receiving state, while the remaining data lines 26 are each individually actuatable between a data transmitting state and a data receiving state by switch 30. In other implementations, each of the data lines 26 are individually actuatable between a data transmitting state and a data receiving state by switch 30.

In one implementation, device 20 may comprise four data lines 26 extending from port 24, wherein at least 1, and up to 4 of the data lines 26 are individually selectively actuatable between a data transmitting state and a data receiving state. In one implementation, such as where port 24 comprises a PCI express port, device 20 may comprise 32 data lines 26 extending from port 24, wherein at least one and up to 32 of the data lines are individually selectively actuatable between a data transmitting state and a data receiving state. In yet other implementations, device 20 may comprise other numbers of data lines 26 extending from port 24, wherein at least one of the data lines is selectively actuatable by switch 30 between a data transmitting state and the data receiving state.

Switch 30 comprises an electronic component that selectively actuates data line 26, and its data transmission lanes 28, between a data transmitting state and a data receiving state. In one implementation, switch 30 selectively connects the data lanes 28 of data line 26 to data receiving hardware or to data transmitting hardware. In some implementations, device 20 may comprise a data receiving buffer that temporarily stores data values received from data line 26, and for subsequent receipt by the data receiving hardware, when data line 26 is in the data receiving state. In some implementations, device 20 may comprise a data transmitting buffer that temporally stores data values from the data transmitting hardware while awaiting transmission by data line 26 when data line 26 is in the data transmitting state. In one implementation, switch 30 may comprise a multiplexor that selectively connects some of data lines 26 to the data transmitting hardware and some of data lines 26 to the data receiving hardware.

Host interface controller 44 comprises an electronic component, such as a processing unit that follows instructions contained in a non-transitory computer-readable medium in the form of a persistent memory or an integrated circuit that follows instructions in a non-transitory computer readable medium in the form of logic elements. Host interface controller 44 controls switch 30 to selectively actuate the pair of data lanes 28 of data line 26 to one of the data transmitting state and a data receiving state based upon at least one data transfer request. In one implementation, host interface controller 44 outputs control signals to switch 30 based upon a single data transfer request. In another implementation, host interface controller 44 outputs control signals to switch 30 based upon a predetermined number of data transfer requests or a particular batch of data transfer requests. The control signals cause switch 30 to actuate data line 26 between the data transmitting state or the data receiving state. Data lines 26 may be in a data transmitting state pursuant to a first data transfer request or pursuant to a first group of data transfer requests between host device 20 and a peripheral device may be in a data receiving state pursuant to a second data transfer request or pursuant to a second group of data transfer requests between host 20 and the same peripheral device. The switching of line 26 between data transmitting and dating receiving states may be independent of the characteristics of the peripheral device which is involved in a data transfer with host device 20.

In one implementation, host interface controller 44 generates and outputs control signals to switch 30 for the actuation of data line 26 between the data transmitting state and the data receiving state based upon the amount of data being transferred pursuant to the at least one data transfer request and the destination for the data. For example, in one implementation, host interface controller 44 receives a data transfer request and determines the amount of data to be transmitted from host device 20 as compared to the amount of data to be received by host device 20. In circumstances where host device 20 is to transmit a larger amount of data as compared to the amount of data to be received by host device 20 pursuant to a data transfer request or a group of data transfer requests, such as when host device 20 is storing data in a remote peripheral memory device, host interface controller 44 may generate and output control signals to switch 30 causing switch 30 to actuate data line 26 to a data transmitting state such that a majority of the data lines 26 extending from port 24 are in the data transmitting state. In circumstances where device 20 is to receive a larger amount of data as compared to the amount of data to be transmitted by host device 20 pursuant to a data transfer request or a group of data transfer requests, such as when host device 20 is reading data from a remote peripheral memory device, host interface controller 44 may generate and output control signals to switch 30 causing switch 30 to actuate data line 26 to a data receiving state such that a majority of the data lines 26 extending from port 24 are in the data receiving state.

In one implementation, host interface controller 44 automatically determines whether to switch data line 26 to a data transmitting state or a data receiving state by comparing a determined amount of data to be transferred pursuant to a single data transfer request or a group of data transfer requests against a predetermined numerical threshold. In another implementation, host interface controller 44 automatically determines whether to switch data line 26 to a data transmission state or a data receiving state by comparing a determined amount of data to be transferred pursuant to a single data transfer request or a group of data transfer requests against a predetermined percentage threshold. For example, what percentage of the total data being transmitted and received comprises data that is transmitted or comprises data that is received.

In some implementations, host interface controller 44 automatically outputs control signals to switch 30 controlling whether data line 26 is actuated to a data transmission state or a data receiving state based upon other characteristics of an individual data transfer request or a group of multiple data transfer requests. For example, in other implementations, host interface controller 44 may determine whether to cause switch 30 to actuate data line 26 to the data transmission state or the data receiving state based upon an identifier, name or tag associated with the data transfer request or associated with a group of data transfer requests, wherein the tag identifies characteristics of the data transfer that may be more suited for certain allocations of the data lines between data transmitting and data receiving states.

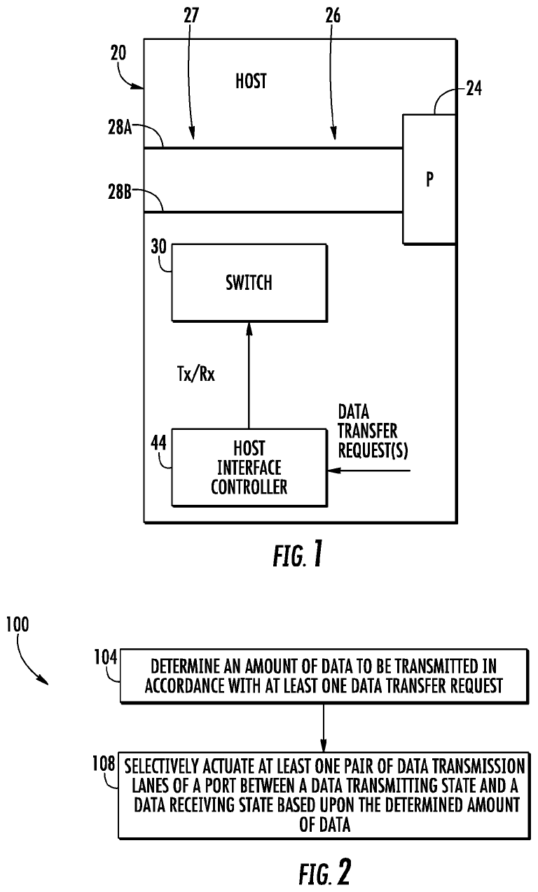

FIG. 2 is a flow diagram of an example method 100 for controlling and I/O system of a host device. Method 100 enhances bandwidth of an I/O system. Although method 100 is described in the context of being carried out by host device 20, it should be appreciated that method 100 may be carried out by other host devices described hereafter or with similar host devices.

As indicated by block 104, host interface controller 44 determines an amount of data to be transmitted in accordance with at least one data transfer request. For example, was interface 44 determines the amount of data that will be transmitted or sent relative to the amount of data that will be received pursuant to at least one data transfer request. As indicated by block 108, host interface controller 44 selectively actuates at least one pair of data transmission lanes 28 of a port 24 between the data transmitting state and a data receiving state based upon the determined amount of data. In one implementation, host interface controller 44 outputs control signals causing a switch, such as switch 30, to actuate at least one data transmission line 26 between the data transmitting state and the data receiving state based upon the determined relative amount of data being transmitted and being received pursuant to the individual data transfer request or pursuant to a group of multiple data transfer requests. By switching data line 26 between either a data transmitting state or a data receiving state based upon whether the majority the amount of data is being transmitted or is being received pursuant to the at least one data transfer request, host device 20 may automatically take into account the characteristics of the particular data transmission transaction and increase the speed of the transaction without changing clock speed, without changing electrical characteristics of the device, without detrimentally impacting signal integrity and/or without introducing additional routing concerns.

FIG. 3 schematically illustrates portions of an example data transfer system 210. System 210 comprises host device 20 (described above) and peripheral device 250. System 210 facilitates faster and more efficient transfer of data between host device 20 and peripheral device 250 by automatically switching data lines between data transmitting states and data receiving states based upon characteristics of a data transfer request or a group of data transfer requests.

Peripheral device 250 comprises port 254, data line 256, switch 260 and peripheral interface controller 274. Port 254 is similar to port 24 of host device 20. Port 254 comprises a connector by which peripheral device 250 may be communicatively connected to another device, such as host device 20. Port 254 may comprise various pins or receptacles facilitating the transmission of electrical signals for transmitting and receiving data signals pursuant to data transfer requests. In one implementation, port 254 may comprise a universal serial bus (USB) type port would follow the USB protocol. In another implementation, port 254 may comprise a Peripheral Component Interconnect Express (PCIe) port which comprises a high-speed serial connection that follows a high-speed serial computer expansion bus standard. In yet other implementations, port 254 may comprise other forms of connections that follow other protocols or standards.

As shown by FIG. 3, port 254 receives a communication cable 240 which is in turn connected to port 24 of host device 20. Communication cable 240 comprises a data line 246 which comprises data lanes 248A and 248B. Although communication cable 2400 is illustrated as comprising a single data line 246, should be appreciated that communication cable 240 may comprise multiple data lines 246 corresponding to the number of data lines 26 of host device 20 extending from port 24 as well as the number of data lines 256 of peripheral device 250 extending from port 254.

Communication cable may comprise additional signal or power transmission lines as well. In one implementation, communication cable 240 comprises a universal serial bus cable. In another implementation, communication cable 240 comprises a PCI express communication cable. In still other implementations, depending upon port 24 and 254, communication cable 240 may comprise other types of communication cables with connections corresponding to other bus protocols.

Data line 256 extends from port 254 and communicates electrical signals, representing data, to other components of device 250. Data line 256 comprises a pair 257 of data lanes 258A, 258B (collectively referred to as lanes 258). Although FIG. 1 schematically illustrates a single data line 26 comprising a single pair 27 of data lanes 258, it should be appreciated that device 250 comprises multiple data lines 256. At least a portion of the total number of data lines 256 are selectively actuatable by switch 260 between a data transmitting state and a data receiving state. In one implementation, a predetermined portion of the total number of data lines 256 is fixed in either a data transmitting state or a data receiving state, while the remaining data lines 256 are each individually actuatable between a data transmitting state and a data receiving state by switch 260. In other implementations, each of the data lines 256 are individually actuatable between a data transmitting state and a data receiving state by switch 260.

In one implementation, device 250 may comprise four data lines 256 extending from port 254, wherein at least 1, and up to 4 of the data lines 256 are individually selectively actuatable between a data transmitting state and a data receiving state. In one implementation, such as where port 254 comprises a PCI express port, device 250 may comprise 32 data lines 256 extending from port 254, wherein at least one and up to 32 of the data lines 256 are individually selectively actuatable between a data transmitting state and a data receiving state. In yet other implementations, device 250 may comprise other numbers of data lines 256 extending from port 254, wherein at least one of the data lines is selectively actuatable by switch 260 between a data transmitting state and the data receiving state.

Switch 260 comprises an electronic component that selectively actuates data line 256, and its data transmission lanes 258, between a data transmitting state and a data receiving state. In one implementation, switch 260 selectively connects the data lanes 258 of data line 256 to either data receiving hardware or data transmitting hardware. In some implementations, device 250 may comprise a data receiving buffer that temporarily stores data values received from data line 256, and for subsequent receipt by the data receiving hardware, when data line 256 is in the data receiving state. In some implementations, device 250 may comprise a data transmitting buffer than temporally stores data values from the data transmitting hardware while awaiting transmission by data line 256 when data line 256 is in the data transmitting state. In one implementation, switch 260 may comprise a multiplexor that selectively connects some of data lines 256 to the data transmitting hardware and some of data lines 256 to the data receiving hardware.

Peripheral interface controller 274 comprises an electronic component, such as a processing unit that follows instructions contained in a non-transitory computer-readable medium in the form of a persistent memory or an integrated circuit that follows instructions in a non-transitory computer-readable medium in the form of logic elements. Peripheral interface controller 274 controls switch 260 to selectively actuate the pair of data lanes 258 of data line 256 to one of the data transmitting state and a data receiving state based upon control signals received from host device 20, such as control signals from host interface controller 44 of host device 20, as indicated by arrow 266. As indicated by arrow 268, peripheral interface controller 274 outputs control signals to switch 260 based upon the control signals received from host device 20.

In one implementation, the control signals are transmitted in a header of a packet instructing peripheral interface controller 274 to output control signals causing switch 260 to actuate data line 256 to either a data transmitting state or a data receiving state. In one implementation, the control signals direct peripheral interface controller 274 to switch data line 256 to a state opposite to that of data line 26 for a particular data transfer request or for a particular group of data transfer requests.

For example, for a data transfer request for a group of data transfer requests where a majority of the data being communicated between host device 20 and peripheral device 250 is being transmitted from host device 20 to peripheral device 250, host interface controller 44 may output first control signals 36 to switch 30 to actuate data line 26 to a data transmission state such that a majority of the total number of data lines connected to port 24 are in the data transmission state. Conversely, host interface controller 44 may transmit control signals 266 to peripheral interface controller 274 causing controller 274 to output control signals 268 to cause switch 260 to actuate data line 256 to a data receiving state such that a majority of the total number of data lines connected to port 254 are in the data receiving state.

For a data transfer request or a group of data transfer requests where a majority of the data being communicated between host device 20 and peripheral device 250 is being transmitted from peripheral device 250 to host device 250, host interface controller 44 may output first control signals 36 to switch 30 causing switch 30 to actuate data line 26 to a data receiving state such that a majority of the total number of data lines connected to port 24 are in the data receiving state. Conversely, host interface controller 44 may transmit control signals 266 to peripheral interface controller 274 causing controller 274 to output control signals 268 to switch 260 causing switch 260 to actuate data line 256 to a data transmitting state such that a majority of the total number of data lines connected to port 254 are in the data transmitting state.

In some implementations, peripheral interface controller 274 may not function as a slave device pursuant to control signals received from host interface controller 44, but instead operate in a fashion similar to that of host interface controller 44. In such an implementation, peripheral interface controller 274 may analyze or otherwise determine from a data transfer request or a group of data transfer requests, the amount of data being transmitted versus the amount of data being received to automatically output control signals 268 causing switch 260 to actuate data line 256 such that a majority (more than half) of the total number of data lines 256 are either in a data transmitting state or a data receiving state.

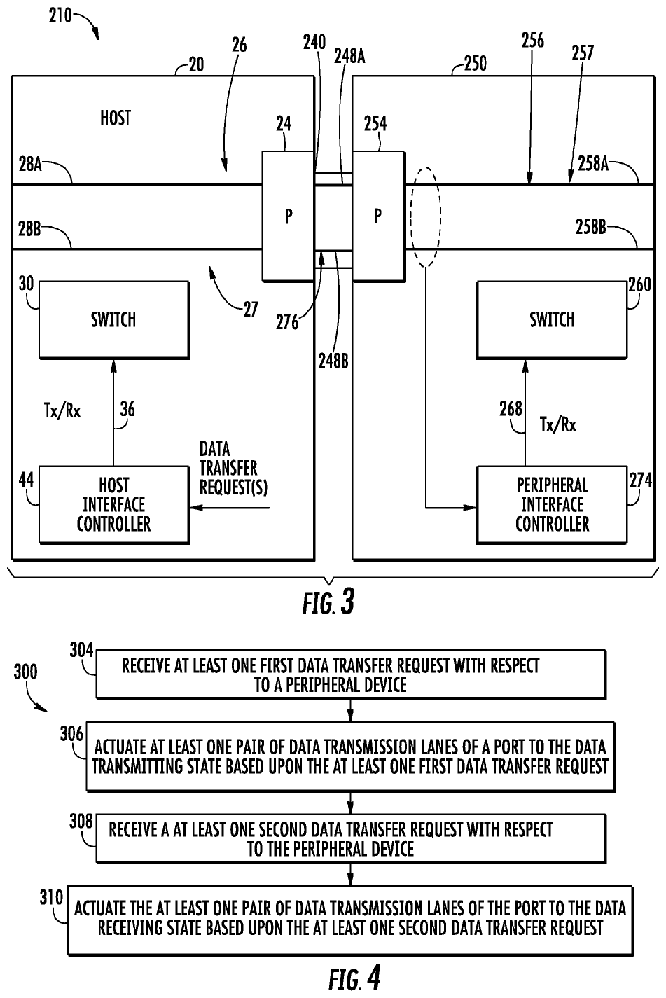

FIG. 4 is a flow diagram of an example method 300 for controlling the I/O system of a host device in communication with a peripheral device. Method 300 enhances bandwidth of an I/O system. Although method 300 is described in the context of being carried out by host device 210 as part of system 210, it should be appreciated that method 300 may be carried out by other host devices described hereafter or in other communication systems.

As indicated by block 304, host device 20 receives at least one first data transfer request with respect to a peripheral device, such as peripheral device 250. The at least one first data transfer request comprises a communication indicating an amount of data to be transferred and destination of the data being transferred. For example, data, such as in the form of data packets, may be transferred from a first memory device and written on a second memory device. Data on a first device may be read by second device. The data transfer may comprise the transmission of data packets and the transmission of acknowledgment or confirmation data messages. With such a data transfer request or a group of data transfer requests, dataflow may be unequal or asymmetrical in that a first amount of data may be transferred from the first device to the second dice while a minority of data is transferred from the second vice to the first device.

As indicated by block 306, host device 20 actuates at least one pair of data transmission lanes 28 (at least one data line 26) of a port 24 to a data transmitting state based upon at least one characteristic of the at least one first data transfer request. In one implementation, the at least one characteristic comprises the amount of data being transferred and the destination for the data. In one implementation, host interface controller 44 of host device 20 determines which data lines 26 or what number of data lines 26 should be in data transmitting states as well as which data lines 26 or what number of data lines 26 should be in data receiving states based upon a comparison of the amount of data to be transferred pursuant to the at least one first data request with a numerical threshold. In another implementation, host interface controller 44 of host device 20 determines which data lines 26 or what number of data lines 26 should be in data transmitting states as well as which data lines 26 or what number of data lines 26 should be in data receiving states based upon what percentage of the total amount of data being transferred is being transmitted from host device 20 as compared to what percentage of the total amount of data being transferred is being received by host device 20, or vice versa.

In one implementation, host device 20 switches at least one data line 26 between a data transmitting state and a data receiving state by outputting control signals which cause switch 30 to actuate the selected data lines 26 to the selected states. In one implementation, the switch selectively connects the selected data lines to data transmitting hardware or data receiving hardware. In some implementations, the switch selectively connects the selected data lines 26 to a data transmitting buffer or a data receiving buffer.

As indicated by block 308, host device 20 receives at least one second data transfer request with respect to the peripheral device 250. The at least one second data transfer request comprises a communication indicating an amount of data to be transferred and destination of the data being transferred. For example, data, such as in the form of data packets, may be transferred from a first memory device and written on a second memory device. Data on a first device may be read by second device. The data transfer may comprise the transmission of data packets and the transmission of acknowledgment or confirmation data messages. With such a data transfer request for a group of data transfer requests, dataflow may be unequal or asymmetrical in that a first amount of data may be transferred from the first device to the second dice while a minority of data is transferred from the second vice to the first device.

As indicated by block 310, host device 20 actuates at least one pair of data transmission lanes 28 (at least one data line 26) of a port 24 to a data transmitting state based upon at least one characteristic of the at least one second data transfer request. In one implementation, the at least one characteristic comprises the amount of data being transferred and the destination for the data. In one implementation, host interface controller 44 of host device 20 determines which data lines 26 or what number of data lines 26 should be in data transmitting states as well as which data lines 26 or what number of data lines 26 should be in data receiving states based upon a comparison of the amount of data to be transferred pursuant to the at least one second data request with a numerical threshold. In another implementation, host interface controller 44 of host device 20 determines which data lines 26 or what number of data lines 26 should be in data transmitting states as well as which data lines 26 or what number of data lines 26 should be in data receiving states based upon a what percentage of the total amount of data being transferred is being transmitted from host device 20 as compared to what percentage of the total amount of data being transferred is being received by host device 20, or vice versa.

In one implementation, host device 20 switches at least one data line 26 between a data transmitting state and a data receiving state by outputting control signals which cause switch 30 to actuate the selected data lines 26 to the selected states. In one implementation, the switch selectively connects the selected data lines to data transmitting hardware or data receiving hardware. In some implementations, the switch selectively connects the selected data lines 26 to a data transmitting buffer or a data receiving buffer.

In one implementation, the number of data lines 26 of host device 20 actuated to the data transmitting state for the at least one first data transfer request is different than the number of data lines 26 of host device 20 actuated to the data transmitting state for the at least one second data transfer request. Likewise, the number of data lines 26 of host device 20 actuated to the data receiving state for the at least one first data transfer request is different than the number of data lines 26 of host device 20 actuated to the data receiving state for the at least one second data transfer request.

Method 300 may likewise be carried out by the peripheral device 250. In one implementation, peripheral interface controller 274 makes the same determinations with respect to an incoming data transfer request as host interface controller 44 and outputs control signals causing switch 260 to actuate at least one of data lines 256 to a data transmitting state or a data receiving state such that an unequal number of data lines 256 are in the data transmitting state as compared to the number of data lines 256 in the data receiving state for the particular data transfer or a particular group of data transfers. In another implementation, peripheral interface controller 274 behaves as a slave device, receiving signals from host device 20 indicating which data lines 256 or what number of data lines 256 are to be actuated to data transmitting states and/or data receiving states based upon the at least one data transfer request.

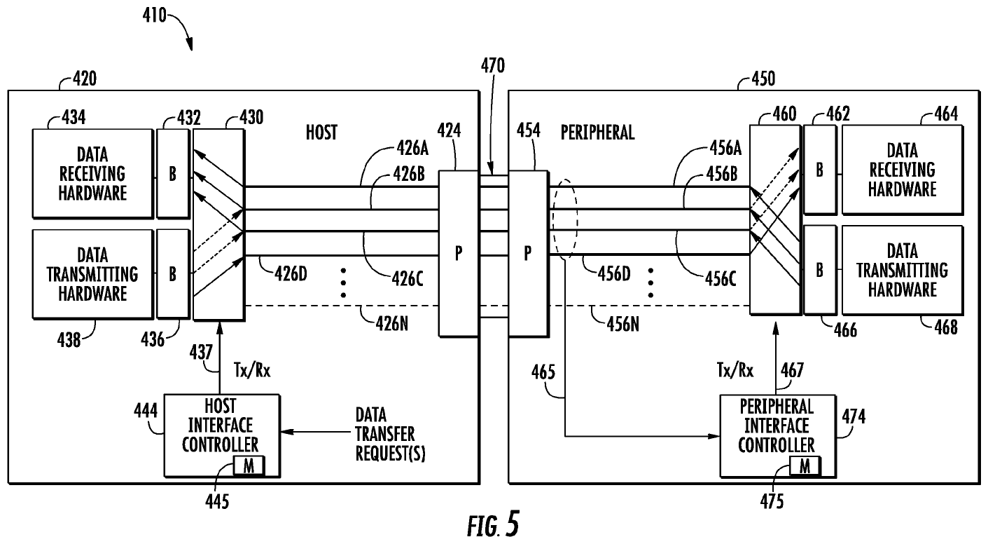

FIG. 5 schematically illustrates portions of an example data transfer system 410. System 410 comprises host device 420 and peripheral device 450. System 410 facilitates faster and more efficient transfer of data between host device 420 and peripheral device 450 by automatically switching data lines between daters transmitting states and data receiving states based upon characteristics of a data transfer request or a group of data transfer requests.

Host device 420 is similar to host device 20 described above in that host device 420 enhances the bandwidth of its I/O system by dynamically actuating at least one pair of data transmission lanes of a port between the data transmitting state and a data receiving state based upon characteristics of at least one data transfer request. Such actuation is dynamic in that the transmitting/receiving state of an individual data transfer line may vary from one data transfer request or group of data transfer requests to another data transfer request or another group of data transfer requests with the same peripheral device.

Host device 420 comprises port 424, data lines 426A, 426B, 426C, 426D (collectively referred to as data lines 426), switch 430, data receiving buffer 432, data receiving hardware 434, data transmitting buffer 436, data transmitting hardware 438 and a host interface controller 444.

Port 424 is similar to port 24 described above except that port 424 is specifically illustrated as being connected to or having data lanes 426. Similar to port 24, port 424 comprises a connector by which host device 420 may be communicatively connected to another device, such as a peripheral device 450. Port 424 may comprise various pins or receptacles facilitating the transmission of electrical signals for transmitting and receiving data signals pursuant to data transfer requests. In one implementation, port 424 may comprise a universal serial bus (USB) type port would follow the USB protocol. In another implementation, port 24 may comprise a Peripheral Component Interconnect Express (PCIe) port which comprises a high-speed serial connection that follows a high-speed serial computer expansion bus standard. In yet other implementations, port 424 may comprise other forms of connections that follow other protocols or standards.

Data lines 426 extend from port 424 and communicates electrical signals, representing data, to data receiving hardware 434 and data transmitting hardware 438. Each of data lines 426 comprises a pair of data lanes 28A, 28B (shown in FIG. 1). At least a portion of the total number of data lines 26 are selectively actuatable by switch 430 between a data transmitting state and a data receiving state. In the example illustrated, each of the data lines 26 are individually actuatable between a data transmitting state and a data receiving state by switch 430. In other implementations, a predetermined portion of the total number of data lines 426 is fixed in either a data transmitting state or a data receiving state, while the remaining data lines 426 are each individually actuatable between a data transmitting state and a data receiving state by switch 430

In the example illustrated, device 420 comprises four data lines 426 extending from port 424, wherein at least 1, and up to 4 of the data lines 26 are individually selectively actuatable between a data transmitting state and a data receiving state. As indicated by broken lines, in some implementations, device 420 may comprise greater than four data lines 462, comprising data lines 426A-426N. For example, in one implementation, such as where port 424 comprises a PCI express port, device 420 may comprise 32 data lines 426 extending from port 24, wherein at least one and up to 32 of the data lines 426 are individually selectively actuatable between a data transmitting state and a data receiving state. In yet other implementations, device 420 may comprise other numbers of data lines 426 extending from port 424, wherein at least one of the data lines is selectively actuatable by switch 430 between a data transmitting state and the data receiving state.

Switch 430 comprises an electronic component that selectively actuates data lines 426, and their data transmission lanes, between a data transmitting state and a data receiving state. In the example illustrated, switch 430 selectively connects the data lines to either data receiving buffer 432 and hardware 434 or data transmitting buffer 436 and hardware 438. In one implementation, switch 430 comprises at least one multiplexor that is actuatable between different connection states in response to control signals from host interface controller 444.

Data receiving buffer 432 comprise at least one register or other memory device that temporarily stores data values received from data lines 26, and for subsequent receipt by the data receiving hardware 434. Data transmitting buffer 436 comprise at least one register or other memory device that temporally stores data values from the data transmitting hardware 438 while waiting transmission by data lines 426. In some implementations, buffers 432 and 436 may be omitted.

Data receiving hardware 434 comprises electronic components that receive and process the data or data signals received through port 424 and data lines 426. In one implementation, the data receiving hardware 434 comprises a processing unit that carries out operations based upon the received data or that stores the received data in a local memory of host device 420. In one implementation the data receiving hardware 434 unwraps the data from the physical transaction and unpackages it to its usable form.

Data transmitting hardware 438 comprises electronic components that transmit data or data signals to peripheral device 450. In one implementation, the data transmitting hardware 434 moves or copies data from a local memory of host device 420. In one implementation, the data transmitting hardware 438 prepares and packages the data for transmission then schedules the physical transmissions.

Host interface controller 444 is similar to host interface controller 44 described. Host interface controller 444 comprises an electronic component, such as a processing unit that follows instructions contained in a non-transitory computer-readable medium 445 in the form of a persistent memory or an integrated circuit that follows instructions in a non-transitory computer-readable medium 445 in the form of logic elements. Host interface controller 444 controls switch 430 to selectively actuate selected data lines 426 to one of the data transmitting state and a data receiving state based upon at least one data transfer request. In one implementation, host interface controller 444 outputs control signals to switch 430 based upon a single data transfer request. In another implementation, host interface controller 444 outputs control signals to switch 430 based upon a predetermined number of data transfer requests or a particular batch of data transfer requests. The control signals cause switch 430 to actuate selected data lines 426 between the data transmitting state or the data receiving state. Data lines 426 may be in a data transmitting state pursuant to a first data transfer request or a first group of data transfer requests between host device 420 and peripheral device 450 and may be in a data receiving state pursuant to a second data transfer request or a second group of data transfer requests between host 420 and the same peripheral device 450. The switching of data lines 426 between data transmitting and dating receiving states may be independent of the characteristics of the peripheral device which is involved in a data transfer with host device 420.

In one implementation, host interface controller 444 generates and outputs control signals to switch 430 for the actuation of data lines 426 between the data transmitting state and the data receiving state based upon the amount of data being transferred pursuant to the at least one data transfer request and the destination for the data. For example, in one implementation, host interface controller 444 receives a data transfer request and determines the amount of data to be transmitted from host device 420 as compared to the amount of data to be received by host device 420. In circumstances where host device 420 is to transmit a larger amount of data as compared to the amount of data to be received by host device 420 pursuant to a data transfer request or a group of data transfer requests, such as when host device 420 is storing data in a remote peripheral memory device, host interface controller 444 may generate and output control signals to switch 430 causing switch 430 to actuate selected data lines 426 to a data transmitting state such that a majority of the data lines 426 extending from port 424 are in the data transmitting state. In circumstances where device 420 is to receive a larger amount of data as compared to the amount of data to be transmitted by host device 420 pursuant to a data transfer request or a group of data transfer requests, such as when host device 420 is reading data from a remote peripheral memory device, host interface controller 444 may generate and output control signals to switch 430 causing switch 430 to actuate selected data lines 426 to a data receiving state such that a majority of the data lines 426 extending from port 424 are in the data receiving state.

In one implementation, host interface controller 444 automatically determines whether to switch selected data lines 426 to a data transmitting state or a data receiving state by comparing a determined amount of data to be transferred pursuant to a single data transfer request or a group of data transfer requests against a predetermined numerical threshold. In another implementation, host interface controller 444 automatically determines whether to switch selected data lines 426 to a data transmission state or a data receiving state by comparing a determined amount of data to be transferred pursuant to a single data transfer request or a group of data transfer requests against a predetermined percentage threshold for example, what percentage of the total data being transmitted and received comprises data that is transmitted or comprises data that is received.

In some implementations, host interface controller 444 automatically outputs control signals to switch 430 controlling whether selected data lines 426 are to be actuated to a data transmission state or a data receiving state based upon other characteristics of an individual data transfer request or a group of multiple data transfer requests. For example, in other implementations, host interface controller 444 may determine whether to cause switch 430 to actuate selected data lines 426 to the data transmission state or the data receiving state based upon an identifier associated with the data transfer request or associated with a group of data transfer requests.

Peripheral device 450 comprises port 454, data lines 456A, 456B, 456C, 456D (collectively referred to as data lines 456), switch 460, data receiving buffer 462, data receiving hardware 464, data transmitting buffer 466, data receiving hardware 468 and peripheral interface controller 474. Port 454 is similar to port 424 of host device 420. Port 454 comprises a connector by which peripheral device 450 may be communicatively connected to another device, such as host device 420. Port 454 may comprise various pins or receptacles facilitating the transmission of electrical signals for transmitting and receiving data signals pursuant to data transfer requests. In one implementation, port 454 may comprise a universal serial bus (USB) type port would follow the USB protocol. In another implementation, port 454 may comprise a Peripheral Component Interconnect Express (PCIe) port which comprises a high-speed serial connection that follows a high-speed serial computer expansion bus standard. In yet other implementations, port 454 may comprise other forms of connections that follow other protocols or standards.

Port 454 receives communication cable 470 which is connected to port 424 of host device 420. Communication cable 470 comprises data lines 476A, 476B, 476C and 476D (collectively referred to as data lines 476) corresponding to data lanes 456. Communication cable 470 may comprise additional signal or power transmission lines as well. In one implementation, communication cable 470 comprises a universal serial bus cable. In another implementation, communication cable 470 comprises a PCI express communication cable. In still other implementations, depending upon port 424 and 454, communication cable 470 may comprise other types of communication cables with connections correspond to other bus protocols.

Data lines 456 extends from port 454 and communicates electrical signals, representing data, to other components of device 450. Data line 456 comprises a pair of data lanes 258A, 258B (shown in FIG. 3). At least a portion of the total number of data lines 456 are selectively actuatable by switch 460 between a data transmitting state and a data receiving state. In one implementation, a predetermined portion of the total number of data lines 456 is fixed in either a data transmitting state or a data receiving state, while the remaining data lines 456 are each individually actuatable between a data transmitting state and a data receiving state by switch 460. In other implementations, each of the data lines 456 are individually actuatable between a data transmitting state and a data receiving state by switch 460.

In the example illustrated, device 450 comprises four data lines 456 extending from port 454, wherein at least 1, and up to 4 of the data lines 456 are individually selectively actuatable between a data transmitting state and a data receiving state. As indicated by broken lines, in some implementations, device 450 may comprise greater than four data lines 456, comprising data lines 456A-456N. For example, in one implementation, such as where port 454 comprises a PCI express port, device 450 may comprise 32 data lines 456 extending from port 454, wherein at least one and up to 32 of the data lines 456 are individually selectively actuatable between a data transmitting state and a data receiving state. In yet other implementations, device 450 may comprise other numbers of data lines 456 extending from port 454, wherein at least one of the data lines is selectively actuatable by switch 460 between a data transmitting state and the data receiving state.

Switch 460 comprises an electronic component that selectively actuates the individual data lines 456, and their data transmission lanes 258, between a data transmitting state and a data receiving state. In the example illustrated, switch 460 selectively connects the data lines 456 to either data receiving buffer 462 and hardware 464 or data transmitting buffer 466 and hardware 468. Buffers 462, 466 and hardware 464, 468 are similar to buffers 432, 436 and hardware 434, 438, respectively, of host device 420. In one implementation, switch 460 may comprise a multiplexor that selectively connects some of data lines 456 to the data transmitting hardware and some of data lines 456 to the data receiving hardware.

Peripheral interface controller 474 comprises an electronic component, such as a processing unit that follows instructions contained in a non-transitory computer-readable medium 475 in the form of a persistent memory or an integrated circuit that follows instructions in a non-transitory computer-readable medium 475 in the form of logic elements. Peripheral interface controller 474 controls switch 460 to selectively actuate selected data lines 456 to one of the data transmitting state and a data receiving state based upon control signals received from host device 420, such as control signals from host interface controller 444 of host device 420, as indicated by arrow 465. As indicated by arrow 467 peripheral interface controller 474 outputs control signals to switch 460 based upon the control signals received from host device 20.

In one implementation, the control signals are transmitted in a header of a packet instructing peripheral interface controller 474 to output control signals causing switch 460 to actuate selected data lines 456 to either a data transmitting state or a data receiving state. In one implementation, the control signals direct peripheral interface controller 474 to switch selected data lines 456 to a state opposite to that of the corresponding data line 426 for a particular data transfer request or for a particular group of data transfer requests.

For example, for a data transfer request for a group of data transfer requests where a majority of the data being communicated between host device 420 and peripheral device 450 is being transmitted from host device 420 to peripheral device 450, host interface controller 444 may output first control signals 437 to switch 430 actuating selected data line 426 to a data transmission state such that a majority of the total number of data lines connected to port 424 are in the data transmission state. Conversely, host interface controller 444 may transmit control signals 465 to peripheral interface controller 474 causing controller 474 to output control signals 467 to switch 460 actuating selected data lines 456 to a data receiving state such that a majority of the total number of data lines connected to port 454 are in the data receiving state.

For a data transfer request for a group of data transfer requests where a majority of the data being transferred between host device 420 and peripheral device 450 is being transmitted from peripheral device 450 to host device 450, host interface controller 444 may output first control signals 437 to switch 430 actuating selected data lines 426 to a data receiving state such that a majority of the total number of data lines connected to port 424 are in the data receiving state. Conversely, host interface controller 444 may transmit control signals 465 to peripheral interface controller 474 causing controller 474 to output control signals 467 to switch 460 actuating selected data lines 456 to a data transmitting state such that a majority of the total number of data lines connected to port 454 are in the data transmitting state.

In some implementations, peripheral interface controller 474 may not function as a slave device pursuant to control signals received from host interface controller 444, but instead operate in a fashion similar to that of host interface controller 444. In such an implementation, peripheral interface controller 474 may analyze or otherwise determine from a data transfer request or a group of data transfer requests, the amount of data being transmitted versus the amount of data being received to automatically output control signals 467 causing switch 460 to actuate selected data lines 456 such that a majority (more than half) of the total number of data lines 456 are either in a data transmitting state or a data receiving state.

FIG. 5 illustrates two different states of switch 430, one state being illustrated with solid line arrows and the other state being illustrated by broken line arrows. In response to determining that a majority of the data being transferred is to be received by host device 420 from peripheral device 450 pursuant to a data transfer request or a group of data transfer requests, host interface controller 444 outputs control signals 437 to switch 430, causing switch 430 to connect data lines 426B and 426C to data receiving buffer 432 while data lines 426A and 426D remain connected to data receiving buffer 432 and data transmitting buffer 436, respectively. As a result, a majority of the data lines 426 are connected to data receiving buffer 432, in data receiving states. At the same time, host interface controller 444 outputs control signals 465 which are communicated to peripheral interface controller 474 causing controller 474 to output control signals 467 which actuate switch 460 to the state shown with solid line arrows. In particular, control signals 467 cause switch 460 to connect data lines 456B and 456C to data transmitting buffer 466 while data lines 456A and 456D remain connected to data transmitting buffer 466 and data receiving buffer 462, respectively. As a result, a majority of the data lines 456 are connected to data transmitting buffer 432, in data transmitting states.

Conversely, in response to determining that a majority of the data being transferred is to be transmitted by host device 420 to peripheral device 450 pursuant to a data transfer request or a group of data transfer requests, host interface controller 444 outputs control signals 437 to switch 430 causing switch 430 to connect data lines 426B and 426C to data transmitting buffer 436 while data lines 426A and 426D remain connected to data receiving buffer 432 and data transmitting buffer 436, respectively. As a result, a majority of the data lines 426 are connected to data transmitting buffer 432, in data transmitting states. At the same time, host interface controller 444 outputs control signals 465 which are communicated to peripheral interface controller 474 causing controller 474 to output control signals 467 which actuate switch 460 to the state shown with broken line arrows. In particular, control signals 467 cause switch 460 to connect data lines 456B and 456C to data receiving buffer 466 while data lines 456A and 456D remain connected to data transmitting buffer 466 and data receiving buffer 462, respectively. As a result, a majority of the data lines 456 are connected to data receiving buffer 432, in data receiving states. As shown by the example, the majority of data lines 426 are actuated to states opposite to the corresponding majority of data lines 456 of peripheral device 450. In some implementations, sufficiently balanced or equal flow may result in interface controller 444 outputting control signals such that an equal number of data lines 426 are in data transmitting and data receiving states while an equal number of data lines 456 are in data transmitting and data receiving states.

Although the present disclosure has been described with reference to example implementations, workers skilled in the art will recognize that changes may be made in form and detail without departing from the scope of the claimed subject matter. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An apparatus comprising:
a host device comprising:
a port;
a pair of data transmission lanes extending from the port;
a switch to selectively actuate the pair of data transmission lanes between a data transmitting state and a data receiving state; and
a host interface controller to control the switch to selectively actuate the pair of data transmission lanes to one of the data transmitting state and the data receiving state based upon at least one data transfer request.

2. The apparatus of claim 1 further comprising a peripheral device, the peripheral device comprising:
a second port;
a second pair of data transmission lanes extending from the second port; and
a second switch to actuate the second pair of data transmission lanes between the data transmitting state and the data receiving state; and
a peripheral interface controller to control the second switch to selectively actuate the second pair of data transmission lines to one of the data transmitting state and the data receiving state in response to control signals from the host interface controller.

3. The apparatus of claim 1, wherein the host device further comprises:
data transmitting hardware; and
data receiving hardware, wherein the switch is to selectively connect the pair of data transmission lanes to the data transmitting hardware to actuate the pair of data transmission lanes to the data transmitting state and is to selectively connect the pair of data transmission lanes to the data receiving hardware to actuate the pair of data transmission lanes to the data receiving state.

4. The apparatus of claim 3, wherein the host device further comprises:
a data transmitting buffer connected to the data transmitting hardware; and
a data receiving buffer connected to the data receiving hardware.

5. The apparatus of claim 1, wherein the port comprises four pairs of data transmission lanes, including the pair of data transmission lanes.

6. The apparatus of claim 1, wherein the port is a PCI Express port comprising up to 32 pairs of data transmission lanes, including the pair of data transmission lanes.

7. The apparatus of claim 1, wherein the host interface controller is to automatically output control signals to the switch to actuate the pair of data lanes to one of the data transmitting state and the data receiving state based upon an amount of data being transmitted and a destination for the data in accordance with the individual data transfer request.

8. The apparatus of claim 1, wherein the host interface controller is to automatically output control signals to the switch to actuate the pair of data lanes to the data transmitting state based upon an amount of data exceeding a predefined threshold and based upon the data being transmitted from the host device in accordance with the individual data transfer request.

9. The apparatus of claim 1, the host controller to automatically output control signals to the switch to actuate the pair of data transmission lanes to the data receiving state based upon an amount data exceeding a predefined threshold and based upon the data being received by the host device in accordance with the individual data transfer request.

10. A method comprising:
determining an amount of data to be transmitted in accordance with at least one data transfer request; and
selectively actuating at least one pair of data transmission lanes of a port between a data transmitting state and a data receiving state based upon the determined amount of data.

11. The method of claim 10 further comprising selectively connecting the at least one pair of data transmission lanes of the port to one of data transmitting hardware and data receiving hardware based upon the determined amount of data.

12. The method of claim 10 comprising:
receiving the at least one data transfer request with respect to a peripheral device;
actuating the at least one pair of data transmission lanes of the port to the data transmitting state based upon the at least one data transfer request;
receiving at least one second data transfer request with respect to the peripheral device; and
actuating the at least one pair of data transmission lanes of the port to the data receiving state based upon the at least one second data transfer request.

13. The method of claim 12, wherein the actuating of the at least one pair of data transmission lanes of the port to the data transmitting state comprises connecting the pair of data transmission lanes to data transmitting hardware and wherein the actuating of the at least one pair of data transmission lanes of the port to the data receiving state comprises connecting the pair of data transmission lanes to data receiving hardware.

14. A non-transitory computer-readable medium containing instructions to direct a processing unit to:
receive at least one data transfer request, the at least one data transfer request being for an amount of data;
compare the amount of data to a predefined threshold; and
output control signals actuating at least one pair of data transmission lanes of a port to a selected one of a data transmitting state and a data receiving state based upon the comparison.

15. The non-transitory computer-readable medium of claim 14, wherein the instructions are to direct the processing unit to:
actuate the at least one pair of data transmission lanes to the data transmitting state for implementing the at least one data transfer request with respect to a peripheral device; and
actuate the at least one pair of data transmission lanes to the data receiving state for implementing at least one second i data transfer request with respect to the peripheral device.
